(19) United States
(12) Patent Application Publication
(10) Pub. No.: US 2011/0071951 A1
(43) Pub. Date: Mar. 24, 2011

(54) SYSTEM AND METHOD FOR MONITORING OCCUPENCY OF A RENTAL PROPERTY

(75) Inventor: Thomas John, New Hyde Park, NY (US)

(73) Assignee: American Gardens Management Co., New Hyde Park, NY (US)

(21) Appl. No.: 12/886,804

(22) Filed: Sep. 21, 2010

Related U.S. Application Data
(60) Provisional application No. 61/244,476, filed on Sep. 22, 2009.

(51) Int. Cl. G06Q 10/00; G06Q 90/00

(52) U.S. Cl. 705/307; 705/500

(57) ABSTRACT

The present invention discloses a system for monitoring the usage of utilities along with other parameters, such as whether a tenant is current with rental payments, to determine whether a tenant is actively occupying a rental property, such as an apartment.

### CROSS-REFERENCE TO RELATED APPLICATION

The present application claims the benefit of U.S. patent application Ser. No. 61/244,476, filed Sep. 22, 2010, which is hereby incorporated by reference in its entirety.

### TECHNICAL FIELD

The present invention relates to monitoring systems and in particular, the present invention relates to a system for monitoring the usage of utilities along with other parameters to determine whether a tenant is actively occupying a rental property, such as an apartment.

### BACKGROUND

Many people live in rental properties which can take the form of rental apartments, sublet properties (e.g., sublet condos) and even rental houses. Unfortunately, tenants may experience difficulties in their lives and become unable to pay the monthly rental payment (fee). Normally, rental payments are due by the first of the month.

Typically, there is a grace period for payment of a monthly rental payment. For example, there may be a seven (7) day grace period for payments after the first of the month. When tenants exceed this grace period, their account falls into arrears. It is very difficult to evict a tenant for failure to pay monthly rental payments and the process is costly and takes a considerable amount of time since the landlord must follow precise rules and go to court to seek a remedy. Unfortunately, many times, after a tenant becomes delinquent in their account, they will “fly by night” so to speak and vacate the apartment in the middle of the night. The landlord is often oblivious to this occurrence and the apartment sits vacant and instead of being a source of revenue, the apartment represents lost revenue.

There is thus a need to better be able to non-invasively monitor whether a rental property and determine whether the property is lying vacant due to a tenant departing after falling behind in rental payments.

### SUMMARY

The present invention discloses a system for monitoring the usage of utilities along with other parameters, such as whether a tenant is current with rental payments, to determine whether a tenant is actively occupying a rental property, such as an apartment.

### BRIEF DESCRIPTION OF THE DRAWINGS

FIG. 1 is schematic view of a usage monitoring system of the present invention; and

FIG. 2 is a schematic showing the various components of the usage monitoring system of the present invention.

### DETAILED DESCRIPTION OF CERTAIN EMBODIMENTS OF THE INVENTION

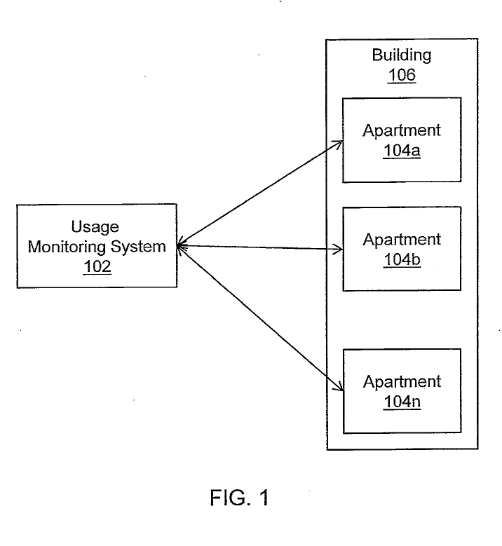

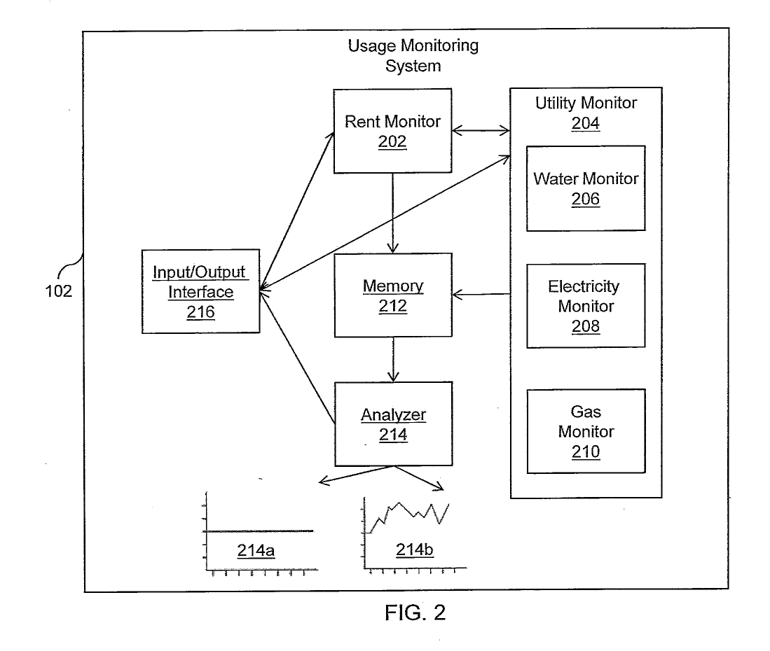

In accordance with one embodiment of the present invention, a monitoring system 102 for monitoring whether a tenant that has fallen into arrears has vacated the property is provided and is illustrated in FIGS. 1-2. FIG. 1 illustrates one exemplary form of a building 106 including various rental properties (apartments) 104a-n monitored by the monitoring system 102; however, it will be appreciated that the building 106 can assume any number of other forms, including but not limited to high rise apartments, villas, private houses, etc. A landlord or an owner of the building 106 can rent the apartments 104a-n to a tenant for an agreed rent, and the rent can include utilities, such as, water, electricity, gas, etc. However, in most situations, the tenant pays for at least some of the utilities and in particular, in most situations, the tenant is at least responsible for the electric bill that is specific to the rented apartment. Therefore, the tenant also pays for the consumption of these utilities and typically, the bill is directly sent to the tenant since the tenant must open and establish an account with the utility company.

As described in detail herein, the monitoring system 102 of the present invention has particular utility to monitor whether a tenant that is in arrears has illegally vacated the property based on monitoring of specific parameters including the consumption of utilities and the financial account of the tenant with the landlord.

The monitoring system 102 is shown in detail in FIG. 2. The usage monitoring system, here after referred to as monitoring system 102 includes a utility monitor 204 for monitoring the consumption of utilities by tenants of apartments 104a-n and a rent monitor 202 for monitoring whether the tenant is in arrears, i.e., the tenant is current with rent payments to the owner of the apartments. The rent monitor 202 thus records and monitors the rent payments paid by the tenants. The rent monitor 202 is typically a part of or in communication with an accounting system (accounting software) of the landlord. For example, the rent monitor 202 can thus be connected to a bank account of the owner which receives the rents from the tenants or any other database, hardware or software where the rent is deposited and can be retrieved or analyzed.

In a particular embodiment of the invention, the rent monitor 202 (rental account software) can include a memory or a database to record the inputs from the owner regarding the rent paid by the tenants. In a certain embodiment, the rent monitor 202 can store the rent information in a memory 212. The memory can also store tenant rental information such as contact details, rent for a particular apartment, due date for rent, grace period for rent, utilities they are responsible, etc. The memory can also store information from the utility monitor 204.

The rent monitor 202 can include computer software, a display device or a meter that displays or monitors rent received from the tenant to the owners bank account or other accounts assigned to keep a record of rent received. The software may monitor the owners account periodically to determine if the amount due has been deposited. Monitoring of the account can be configured by the owner for any particular date and time.

In other words, the rent monitor 202 is a module that keeps track of whether any particular tenant account is in arrears. For example, the software is an accounting software where tenant payments are tracked and the status of each account can be determined at any time (e.g., amount owed, date of payment, payment amount). For example, if a tenant is in arrears, the accounting software can flag the particular account(s) that is in arrears and indicate as such, e.g., using a message, account flag, etc.

In an embodiment of the invention, the rent monitor 202 can be connected to the utility monitor 204 to collect utility information. The rent monitor 202 is commutatively coupled to the memory 212 to share or store records including received rent payments.

The utility monitor 204 includes devices for monitoring the consumption of utilities. The utility monitor 204 can include one or more monitors including a water monitor 206 to monitor the consumption of water; an electricity monitor 208 to monitor the consumption of electricity; a gas monitor 210 to monitor the consumption of gas by the tenants of the apartments 104a-n. It will be appreciated that the utility monitor can include other devices to monitor other utilities that are provided to the apartments.

The water monitor 206 can be connected to a water metering device of the apartments, an inlet of water pipe connected to the apartments or any convenient location in the apartments where the consumption of water can be monitored accurately. For example, the water monitor 206 can be connected to various taps or water outlets of the apartments. The water monitor 206 can include a water sensor to monitor water outflow from water outlets. The water monitor can be in a form of a data logger connected to the water metering devices. Therefore, the consumption of water in the apartments is monitored and logged by the water monitor and stored in the memory 212. The water monitor 206 can be connected to water metering devices of the apartments 104a-n through a wired or a wireless connection.

The electricity monitor 208 can be connected to electricity meters of the apartments 104a-n. Same as the water monitor 206, the electricity monitor 208 can be connected to a main power meter of the apartments, or various electricity points or electric junctions or wherever in the apartment where the electricity consumption can be accurately monitored. The electricity monitor can be in a form of a data logger connected to the electricity monitors to monitor the consumption of electricity. Therefore, the consumption of electricity in the apartments is monitored and logged by the electricity monitor and stored in the memory 212. The electricity monitor 208 can be connected to electricity meters of the apartments through a wired or a wireless connection.

The gas monitor 210 can be connected to gas metering devices of the apartments 104a-n. For example, the apartments can have connections for cooking gas that is monitored in the apartment. Same as the water monitor 206 and the electricity monitor 208, the gas monitor can be connected to a main gas outlet or various gas outlets of apartments or any convenient location where gas can be accurately monitored. The gas monitor can be in a form of a data logger connected to the electricity monitors to monitor the consumption of gas. Therefore, the consumption of gas in the apartments is monitored and logged by the gas monitor and stored in the memory 212. The gas monitor can be connected to gas metering devices of the apartments through a wired or a wireless connection.

The utility monitor 204 can monitor the consumption of utilities regularly from the apartments 104a-n. Also, the utility monitor 204 can be configured to monitor regularly after a pre-defined time interval. For example, the utility monitor 204 can monitor the consumption of the utilities after the pre-defined time intervals such as after the rent payment due date or after the rent grace period or anytime the owners wants to obtain the readings of the usage of the utilities, the date and time of monitoring can be defined as an automated process and so forth.

The memory 210 includes a database with information such as apartment numbers, water, electricity, gas and other utility consumption by each apartment, tenant rental information and tenant details. Further, the information can be maintained based on the pre-defined time intervals. Implementation of the memory can be by any conventional storage media such as a magnetic tape, an optical storage media, a compact disc, or a floppy disc. Alternatively, the memory can be a random access memory, a read only memory, or other type of electronic storage. The memory, at least in part, can be located on a remote storage system. The information contained in the memory 212 is analyzed by an analyzer 214.

The analyzer 214 processes the information stored in the memory 212 and generates messages, alerts or other graphical representations. In an embodiment of the invention, the analyzer 214 processes the information to generate graphs based on the tenant rent information and utility consumption information stored in the memory 212 for the apartments 104a-n. Therefore, monitoring utility consumption in the apartment can be plotted in a graphical representation by taking the values from utility consumption information stored in the memory.

The user can select the monitoring window in that the window for monitoring the data obtained by the utilities monitors can be selected by the user. For example, the consumption utilities can be monitored for a predetermined time period, such as a given number of hours, e.g., 24 hrs, 48 hrs, 72 hrs, etc. The analyzer 214 does not necessarily have to product graphs but instead, the analyzer 214 can simply compare stored values.

The graphs can be plotted taking into consideration, if there is no usage of water then reading of utility consumption will be constant, hence a steady graph can be plotted as shown in FIG. 214a. Whereas, if the utilities are utilized in the apartment then readings will not be constant and there will be a fluctuating graph as shown in FIG. 214b. There can be a number of ways the values can be displayed such as bar graph, pie chart etc. Similar graphical representations can be done for other utilities.

The analyzer 214 also first determines whether a particular tenant is current, e.g., the rent has been paid by a tenant. If the rent is not paid within the due date or grace period or any other date defined by the owner, the account is marked (flagged) as being in arrears, the analyzer 214 checks for information regarding the utility consumption and determines whether the utility usage follows a particular profile. This automatic check by the analyzer to determine the payment of rent and utility consumption informs the owner whether the tenant actually used the apartment for a given time after falling into arrears. In an embodiment of the invention, a steady or a constant graph indicates no consumption of utilities. Similarly, a fluctuating graph indicates the usage of utilities in the apartments 104a-n. In other words, if a tenant is not occupying a rental property, then a review of the utilities consumption over a predetermined period of time, such as 48 hours, will yield values that are steady (constant) over the predetermined period of time (e.g., 48 hours) or do not exceed a predetermined threshold (e.g., a 5% fluctuation over the period of time). When there is no or little fluctuation in the usage values of one or more utilities, especially electricity, this is a good indicator that a tenant is not occupying the apartment over the predetermined period of time.

In certain embodiment of the invention, the utility monitor 204 can plot values of the utility consumption in a graphical manner, pie chat, bar graph or any other display to help the owner understand the usage of the utility in a visual manner and stored the information in the memory 212.

The output from the analyzer 214 is sent to Input/Output (IO) interface 216. The analyzer can be connected IO through a wired or a wireless connection. The IO interface can be a display device such as computer, PDA, or printers for printing the data.

It will therefore be appreciated that the present invention is in the form of a system that monitors for events that are indicative that the tenant has illegally vacated the rental property and not paid for the rental property. In particular, the first criteria that must be met is that the tenant is behind on his/her account. In other words, the tenant is delinquent in payment. The second criteria that is met is that one or more utilities accounts has a usage profile over a predetermined period of time that meets a certain criteria selected by the user. For example and in contrast to conventional monitoring systems, the present system is not tracking the total overall utility usage over a predetermined period of time and is also not tracking or looking for a sudden increase or spike in usage. In contrast, the monitoring system of the present invention monitors utility usage for fairly constant (flat-line) utility usage or usage that has only very minor fluctuations that would not be the result of human occupancy. Once these two conditions exist, the present invention can flag or otherwise mark this particular account as being a suspicious account where the tenant may have vacated without notifying the landlord. At the very least, the landlord is put on notice and can take more investigative measures, such as a physical inspection of the rental property, attempting to contact the tenant, etc. If the landlord can confirm that the tenant has vacated, then additional measures can be taken and the apartment can be placed back on the market much quicker then otherwise possible resulting in the revenue stream beginning again.

The manner of notifying the landlord can take any number of different forms including sending electronic messages, such as text messages, emails, etc. The notification can take other forms including an automated telephone call, etc.

While the invention has been described in connection with certain embodiments thereof, the invention is capable of being practiced in other forms and using other materials and structures. Accordingly, the invention is defined by the recitations in the claims appended hereto and equivalents thereof.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions can be loaded onto one or more general-purpose computers, special purpose computers, or other programmable data processing translator to produce machines, such that the instructions, which execute on the computers or other programmable data processing translator create means for implementing the functions specified in the block or blocks. Such computer program instructions can also be stored in a computer-readable memory that can direct a computer or other programmable data processing apparatus to function in a particular manner, such that the instructions stored in the computer-readable memory produce an article of manufacture including instruction means that implement the function specified in the block or blocks. Furthermore, such computer program instructions can be made available for download and/or downloaded over a communication network.

What is claimed is:

1. A system for monitoring whether a tenant has vacated a rental property comprising:
a rent monitor module that includes memory and stores tenant identification information and rent payment information, wherein the rent monitor module determines and flags those tenant accounts in arrears;
a utility monitor module that includes memory and is configured to monitor the consumption of utilities in a particular tenant property; and
an analyzer that analyzes rent payment information and utility usage information that is stored in the utility monitor module, wherein the analyzer is configured to identify and flag a tenant property as being possibly vacated when: (1) the tenant account for the tenant property is in arrears; and (2) the utility usage information follows a particular profile.

2. The system of claim 1, wherein the rent monitor module, the utility monitor module and the analyzer are part of a personal computer.

3. The system of claim 1, wherein the utility monitor module includes at least one monitor selected from the group consisting of: a water monitor, an electricity monitor and a gas monitor.

4. The system of claim 1, wherein the tenant account is considered in arrears when a grace period of timely payment of the rent payment has passed.

5. The system of claim 1, wherein the particular profile comprises a fluctuating profile of utility usage.

6. A method for monitoring whether a tenant has vacated a rental property comprising the steps of:
determining whether an account of a particular tenant is in arrears;
determining whether utility usage information indicates that a particular tenant has vacated the rental property; and
if the particular tenant is in arrears and the utility usage information fits a particular profile that indicates that the tenant has vacated the rental property, then an alert is generated.
